(19) United States
(12) Patent Application Publication
(10) Pub. No.: US 2008/0093013 A1
(43) Pub. Date: Apr. 24, 2008

(54) Methods for the production of components using veneer-film composite

(75) Inventor: Henry Muller, Altfraunhofen (DE)

Correspondence Address: WOLF GREENFIELD & SACKS, P.C., 600 ATLANTIC AVENUE, BOSTON, MA, 02210-2206, US

(73) Assignee: Lisa Draxlmaier GMBH, Vilsbiburg (DE)

(21) Appl. No.: 11/973,642

(22) Filed: Oct. 9, 2007

(30) Foreign Application Priority Data
Oct. 10, 2006 (DE) DE102006047950.5

(51) Int. Cl. B32B 38/10; B32B 37/12; B32B 38/04

(52) U.S. Cl. 156/153; 156/256; 156/60

(57) ABSTRACT

A method for the production of a component with a decorative and a face layer is provided. A decorative layer and a face layer are joined to create a composite. The composite is then bonded to a substrate in order to produce a finished component.

### CROSS REFERENCE TO RELATED APPLICATION

Foreign priority benefits are claimed under 35 U.S.C. §119(a)-(d) of German Application No. DE 10 2006 047 950.5, filed Oct. 10, 2006, which is hereby incorporated by reference in its entirety.

### BACKGROUND

1. Field

Aspects of the invention relate to methods for the production of components having decorative and face layers, and in particular, for the production of a decorative trim part for use in vehicles, such as motor vehicles.

2. Discussion of Related Art

Components having the appearance of real wood veneer, such as those installed in motor vehicles as trim parts, are usually formed, in sequence, by applying a veneer layer composition to a substrate, then applying a transparent layer of lacquer or a plastic film to the veneer layer. The substrate is frequently a die-cast part or is composed of a hard plastic and is molded as desired based on where the component will be installed. The component may be provided with cut-outs for switches and the like. The veneer layer may be a single-layer or a multi-layer wood or luxury wood veneer, which is applied to the upper side of the substrate that faces away from the installation location. The transparent layer serves on the one hand, to increase the visual attractiveness of the veneer layer by creating a depth effect and a shiny surface, and on the other hand, to protect the veneer layer against damage and environmental impacts.

Although the components referred to are produced by many methods, common to all methods to date, however, is that the combination of substrate and veneer layer is produced first and subsequently the visible side of the veneer layer is coated with the transparent layer. For this, a suitable substrate is pressed with a veneer composition made, for example, from luxury wood veneer, blind veneers and/or metal foils and adhesive films. The veneer composition may then be post-worked by grinding, cementing, milling, coloring, etc. A lacquer (e.g. UPE lacquer) or other coating, for example, a thin coat of PU by the RIM method, may be applied to the veneer. Following lacquering or coating, the part is then ground and polished.

An example of uniting of substrate and veneer layer with subsequent lacquering is described in DE 198 18 232 A1 wherein a phenol film is inserted and cured as a bonding agent between the substrate and veneer. A lacquer is then applied to this combination. In EP 1 360 089 B1, a component comprising a prefabricated substrate and veneer is adhesively bonded with a plastic film, e.g. of polycarbonate. The bonding of film and substrate is brought about by pressing an adhesive between the film and substrate. In DE 199 57 850 A1, a three-dimensional covering layer is molded onto the substrate. Isostatic pressure of a liquid acts on the covering layer in a mold and thus presses the covering layer against the substrate.

In alternative methods, the veneer composition is produced and preformed, placed in an injection molding tool, and then back-molded with a suitable injection molding material. Finally, as before, a lacquer or a film is applied to the substrate/veneer combination.

Drawbacks of these methods exist, however. For example, and without limiting the scope of the invention, a high level of effort, and consequently high costs, are associated with these methods. Furthermore, the veneer layer that is to be applied or that is already applied to a substrate is subjected to high tensile stress during the deformation that may be necessary to adapt the component to the installation space. This may lead to increased crack formation in the veneer layer, resulting in a high proportion of faulty parts. Such crack formation may also negatively effect surface machining of the veneer before bonding with the substrate such that it is difficult to meet the traditionally high quality requirements for these components.

### SUMMARY

According to one embodiment, a method for the production of a component with decorative and face layers is provided. The method includes creating a composite of a decorative layer and face layer; independently, creating or providing a substrate; and thereafter bonding the substrate to the composite.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 is a diagrammatic exploded side view of one embodiment of a component;

FIG. 2 is a diagrammatic exploded side view of one embodiment of the component of FIG. 1;

FIG. 3 is a diagrammatic side view of one embodiment of a veneer layer;

FIG. 3a is a diagrammatic exploded side view of the veneer layer of FIG. 3;

FIG. 4 is a diagrammatic perspective front view of the veneer layer of FIG. 3; and

FIG. 5 is a diagrammatic perspective back view of the film layer of FIG. 2.

### DETAILED DESCRIPTION

Aspects of the invention are directed to a method for the production of components having a decorative and a face layer and which can be carried out in a simple and cost-effective manner without compromises in the quality of the surface of the finished components.

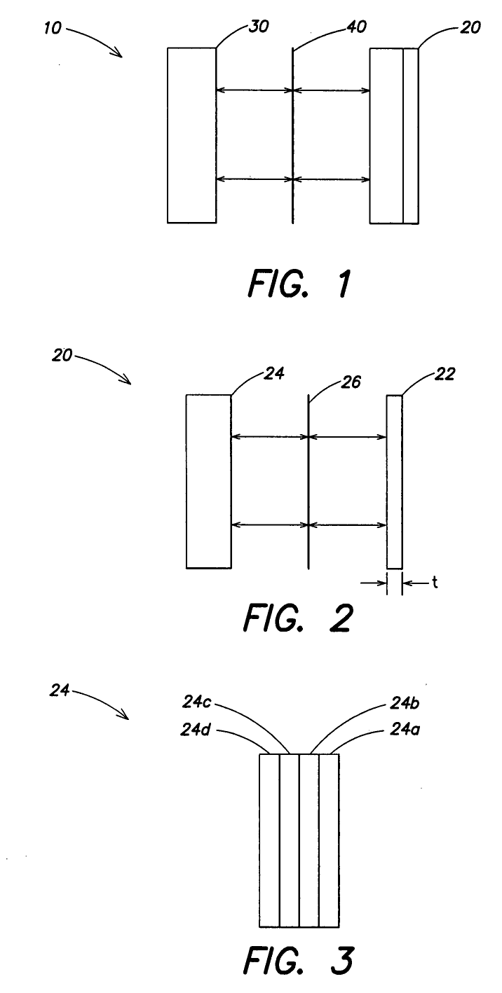

In one embodiment, as shown in FIGS. 1 and 2, a component 10 is formed from a composite 20 of decorative layer 24 and face layer 22, and an independently created or provided substrate 30 bonded to the composite 20 of decorative layer and face layer. In one embodiment, both the composite 20 and also the bonding thereof to the substrate 30 may be generated, for example, by pressing, optionally under thermal load. Other suitable attachment arrangements may be employed, as the present invention is not limited in this respect.

In one embodiment, the decorative layer, being not applied first to the substrate, can be finish-treated at an early stage when it still exists in webs or large pieces. The face layer also need not be preformed at this stage. Thus, processes such as the application of adhesive or further treatment measures such as printing of the decorative layer and/or the face layer can be implemented significantly more cost-effectively by comparison with conventional methods. Also, creation of the composite of the decorative and face layers makes it possible for the decorative layer, bonded to the face layer, to be held by the face layer during deformation for the curved areas of the component without visible cracks arising.

In one embodiment, as shown in FIG. 2, the composite 20 of decorative 24 and face 22 layers is created by pressing the decorative layer and the face layer with the aid of an adhesive 26. In one embodiment, the adhesive 26 is transparent and lightfast in order not to impair the view onto the decorative finish and not to yellow or age due to the effects of light, this being particularly relevant in motor vehicles due to exposure to strong sunlight.

Also, in one embodiment, as shown in FIG. 1, the composite 20 of decorative layer and face layer may be bonded to the substrate 30 using an adhesive 40.

In both cases, i.e. both with the adhesive 26 between the decorative and face layer and the adhesive 40 between the decorative layer and substrate, the adhesive may be a curing resin, e.g. phenol, PUR, melamine or urea/melamine compound. The permanent curing ensures a secure bond and also increases the component's stability. Other suitable bonding agents may be employed, as the present invention is not limited in this respect.

In one embodiment, the substrate 30 is formed by back-molding or back-pressing of the composite 20 of decorative layer and face layer with an appropriate material, such as an injection molding material. This makes it possible to shape the component 10 in any way desired such that it can easily be adapted to the specific conditions and/or dimensions of the space where the component is to be installed.

However, in another embodiment, the substrate 30 may be pre-fabricated, as the present invention is not limited in this respect. In one embodiment, the substrate 30 may be produced by injection molding or by other suitable techniques. In one embodiment, the substrate 30 is formed of plastic, such as polyamide, PET or polypropylene sulphide. Metal substrates produced by die-casting, e.g. of aluminum, are also possible, as the present invention is not limited in this respect.

In one embodiment, the composite 20 of decorative layer 24 and face layer 22 is preformed or cut to size prior to bonding to the substrate. This makes application to the substrate significantly easier.

In one embodiment, as shown in FIG. 3, the decorative layer 24 comprises a wood veneer or a veneer composition comprising one or a plurality of wood veneers 24a, 24b, 24c, and 24d. Adhesive films and/or metal foils 25a, 25b, 25c, as shown in FIG. 3a, may be provided between the veneer layers. Other suitable layers 25a, 25b, 25c, 25d, such as woven fabrics, knitted fabrics or non-woven fabrics of textile, metal or plastics may be employed. In one embodiment, the decorative layer 24 can be covered with layer 25d formed of a non-woven fabric. This layer 25d may be applied prior to bonding the decorative layer to the face layer. An attractive layer may be achieved as a result.

The face layer 22 may be a PC, PMMA or PC-PMMA combination film. These types of film are characterized by their high durability and their ability to form films with a high surface quality. Other suitable materials may be employed, as the present invention is not limited in this regard.

In one embodiment, the face layer 22 is transparent or translucent (see-through). A transparent face layer, in particular one made of PC, PMMA or a combination thereof, ensures high visibility of the decorative layer underneath it. A translucent face layer likewise achieves attractive visual effects with an appropriate choice of decoration.

In one embodiment, as shown in FIG. 2, the face layer 22 has a thickness “t” in a range between approximately 0.015 mm and approximately 2 mm. In one embodiment, the thickness “t” is in a range between approximately 0.025 mm and approximately 1 mm. This thickness of the face layer, which is reduced by comparison with face layers to date, allows for greater design freedom in the choice of radii of curvature to be followed by the finished component since smaller radii are possible during deformation of the composite 20. Other suitable thicknesses may be employed, as the present invention is not limited in this regard.

In one embodiment, the decorative layer 24 is subjected to coloring and/or is ground, cemented and polished prior to bonding to the face layer 22. Thus, visual design features of the composite 20 can be determined prior to it taking on the shape of the substrate as a result of bonding to the substrate 30.

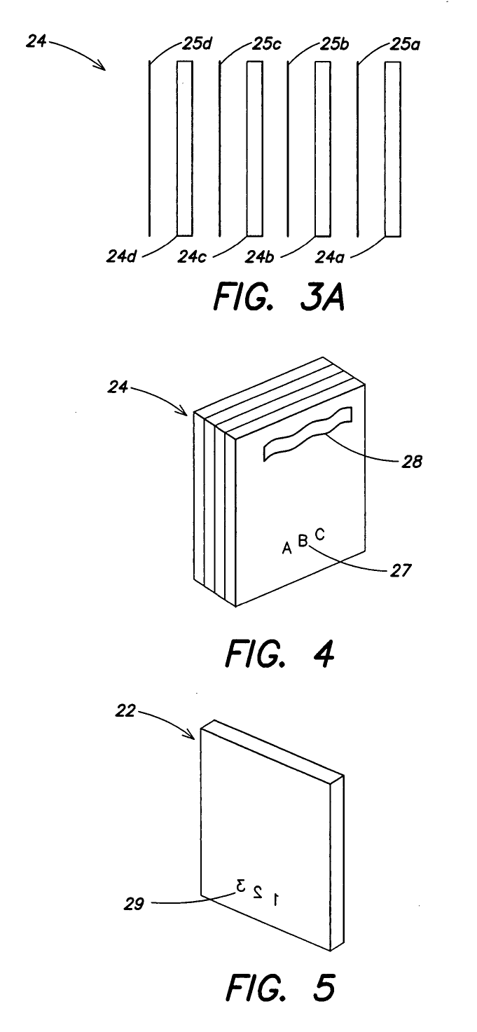

In one embodiment, as shown in FIG. 4, the decorative layer 24 is printed with print 27 on the visible side prior to creation of the composite 20. In this way, it may be possible to apply particularly hard-wearing lettering or symbols because the print 27 is sandwiched between the decorative layer 24 and the face layer 22, and is thus not exposed.

In one embodiment, the decorative layer 24 is provided with one or more inlays 28 on the visible side prior to creation of the composite 20. In the finished component 10, the inlay(s) then remain lying on the inside between the decorative layer 24 and the face layer 20 and as a result they cannot become dirty, worn, etc., ensuring that the decoration is durable.

In one embodiment, as shown in FIG. 5, the face layer 22 is partially or completely printed on the front or back prior to creation of the composite. In this manner, it is possible, particularly in the case of printing on the back, to apply resistant lettering for the component 10. Such printing may be located in an appropriate manner, such as close to cut-outs for switches or the like.

In one embodiment, the face layer 22 is coated on the outer side with a scratch-resistant layer or an easy-to-clean layer. In this manner, it is possible to produce decorative components, which are particularly resistant to high wear and which may be used, for example, in motor vehicles in decorative areas that are frequently handled or serve as storage areas. Also, a component can be created that is suitable for environments exposed to dirt.

The decorative layer, in one embodiment, may be partially lasered prior to creation of the composite of decorative layer and face layer. Removal of material or the formation of a cut-out using a laser may make it possible to create visually attractive lighting effects when viewing the component by providing illumination behind the decorative layer, for example. Alternatively, a laser may also be used to alter the coloring of the component in specific areas, in order, for example, to create patterns or lettering on the decorative surface.

One example of forming the component 10 will now be described.

A wood veneer 24 comprising a plurality of veneer layers 24a, 24b, 24c, 24d and interstitial layers 25a, 25b, 25c of adhesive is produced and is provided on the visible side with inlays 28. The veneer composition is then coated on the visible side with a layer 22 of thermally curing phenol resin, e.g. by knife spreading, and covered with a polycarbonate film. The veneer-film composite 20 is heat treated and pressed to cure the transparent PC resin. This composite 20 is subsequently preformed and cut to size according to its final shape.

After preforming of the substrate 30 and creation of the veneer-film composite 20 carried out separately thereto, the substrate 30 and composite 20 are bonded using an adhesive 40, e.g., a thermally curing resin which need not, however, be transparent in this case, and pressed to form the component 10.

Having thus described several aspects of at least one embodiment of this invention, it is to be appreciated various alterations, modifications, and improvements will readily occur to those skilled in the art. Such alterations, modification, and improvements are intended to be part of this disclosure, and are intended to be within the spirit and scope of the invention. Accordingly, the description and drawings herein are by way of example only.

What is claimed is:

1. A method for the production of a component with decorative and face layers, the method comprising:
(a) creating a composite of a decorative layer and face layer;
(b) independently of (a), creating or providing a substrate; and
(c) thereafter, bonding the substrate to the composite.

2. The method according to claim 1, wherein creating the composite comprises pressing the decorative layer and face layer using an adhesive.

3. The method according to claim 1, wherein bonding the substrate to the composite comprises laminating the substrate to the composite using an adhesive.

4. The method according to claim 1, wherein creating or providing the substrate comprises forming the substrate by back-molding or back-pressing a material to the composite of decorative layer and face layer.

5. The method according to claim 1, wherein creating or providing the substrate comprises pre-fabricating the substrate.

6. The method according to claim 4, further comprising preforming the composite prior to bonding to the substrate.

7. The method according to claim 4, further comprising cutting the composite to size prior to bonding to the substrate.

8. The method according to claim 1, further comprising providing the decorative layer as a veneer or a veneer composition comprising one or a plurality of veneers and at least one of adhesive films, metal foils, woven fabrics, knitted fabrics, non-woven fabrics of textile, metal and plastics.

9. The method according to claim 1, further comprising providing the face layer having a PC, PMMA or PC-PMMA combination film.

10. The method according to claim 1, further comprising providing the face layer having a thickness between approximately 0.015 mm and approximately 2 mm.

11. The method according to claim 1, further comprising providing the face layer having a thickness between approximately 0.025 mm and approximately 1 mm.

12. The method according to claim 1, further comprising providing a transparent or translucent face layer.

13. The method according to claim 1, further comprising coloring and/or grinding, cementing and polishing the decorative layer prior to bonding to the face layer.

14. The method according to claim 1, further comprising partially or completely printing a front or back of the face layer prior to creating the composite.

15. The method according to claim 1, further comprising printing on a visible side of the decorative layer prior to creating the composite.

16. The method according to o claim 1, further comprising providing the decorative layer with an inlay on a visible side of the decorative layer prior to creating the composite.

17. The method according to claim 1, further comprising coating the face layer on an outer side with a scratch-resistant layer or an easy-to-clean layer.

18. The method according to claim 1, further comprising applying a non-woven fabric to the decorative layer prior to bonding the decorative layer to the face layer.

19. The method according to claim 1, further comprising partially lasering the decorative layer prior to creating the composite.
